(19) United States
(12) Patent Application Publication
(10) Pub. No.: US 2021/0065015 A1
(43) Pub. Date: Mar. 4, 2021

(54) COMPUTERIZED PLATFORM FOR FACILITATING GROUP BASED DECISION MAKING

(71) Applicant: IDK TONIGHT, LLC, New York, NY (US)

(72) Inventor: Jordan Taylor Scott, New York, NY (US)

(21) Appl. No.: 17/011,176

(22) Filed: Sep. 3, 2020

Related U.S. Application Data
(60) Provisional application No. 62/895,974, filed on Sep. 4, 2019.

(51) Int. Cl. G06N 5/02

(52) U.S. Cl. CPC G06N 5/02

(57) ABSTRACT

A system and method that facilitates group based decisions. A system includes an interest discovery process including: outputting content items to clients for display; receiving responses from the clients, wherein each response is indicative of an interest in a displayed content item; and identifying matches among group members based on the responses; and a decision builder process that includes: receiving a decision outline from an initiator, wherein the decision outline specifies a decision point; outputting designated content items to the initiator capable of fulfilling the decision point, wherein the designated content items are based on matches made by the interest discovery process; receiving a subset of the designated content items from the initiator and outputting the subset to another group member; and receiving from the other group member a choice from the subset and determining whether a consensus is obtained by the group for the decision.

### BACKGROUND OF THE DISCLOSURE

In today's highly connected world, collaboration often occurs using any number of available interfaces, e.g., email, texting, video conferencing, teleconferencing, etc. Such tools however do little to actually enhance the collaborative process, particularly when attempting to reach consensus on decisions. Current technology solutions can even detract from the decision making process, e.g., video conferencing typically does not allow multiple users to speak at the same time; text messages may convey unintended meanings, etc.

Group based decision making is further impeded by interpersonal relationships and biases that occur by members of a group, e.g., stronger personalities often tend to drive the decision making process, arguments often occur for reasons not associated with the actual issue at hand, etc. Accordingly, group based decisions are often made in an ad hoc manner where one or more users do not adequately participate and simply accede to a decision, despite having significant reservations.

### BRIEF DESCRIPTION OF THE DISCLOSURE

Aspects of this disclosure provide a computerized platform for facilitating group based decision making.

A first aspect of the disclosure provides a system, comprising: a memory; and a processor coupled to the memory and configured to facilitate decision making for a group by implementing: an interest discovery process that includes: outputting curated content items to client devices for display; receiving and storing responses from the client devices, wherein each response is indicative of an interest in a displayed content item for a user; and identifying interest matches among group members based on the responses; and a decision builder process that includes: receiving a decision outline from an initiator via a client device, wherein the decision outline specifies at least one required decision point; outputting designated content items to the initiator capable of fulfilling the required decision point, wherein the designated content items are compiled based on interest matches made by the interest discovery process; receiving a subset of the designated content items from the initiator and outputting the subset to at least one other group member; receiving from the at least one other group member a choice associated with the subset and determining whether a consensus is obtained by the group for the decision point.

A second aspect of the disclosure provides a computer program product stored on a non-transitory computer readable medium, which when executed by a computing system having a processor and a memory, facilitates a group decision making process, the program product comprising: a first graphical user interface (GUI) for discovering user interests that includes a method of: displaying curated content items; receiving user input responses, wherein each response is indicative of an interest in a displayed content item; and outputting the responses to a remote server; and a second GUI that facilitates a decision making process for a group of users by an initiator that includes a method of: generating a decision outline in response to user selectable inputs, wherein the decision outline specifies at least one required decision point; displaying designated content items capable of fulfilling the required decision point, wherein the designated content items are compiled based on interest matches between the initiator and at least one other group member; collecting user input selections from the designated content items that form a subset of designated content items, and forwarding the subset to the server for dissemination to the at least one other group member; and receiving, via the server, a choice from the subset made by the at least one other group member, indicating a consensus for the decision point.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts an illustrative decision making platform, in accordance with an illustrative embodiment.

FIG. 2 depicts a flow diagram of a process of implementing aspects of the decision making platform, in accordance with an illustrative embodiment.

FIG. 3 shows a content processing system in accordance with an illustrative embodiment.

FIG. 4 depicts a discovery GUI showing a content item in accordance with an illustrative embodiment.

FIG. 5 depicts swiping action of content items, in accordance with an illustrative embodiment.

FIG. 6 depicts a discovery GUI showing a match, in accordance with an illustrative embodiment.

FIGS. 7A, 7B, 7C depict GUIs for building an outline, in accordance with an illustrative embodiment.

FIGS. 8A, 8B, 8C depict GUIs for building a decision, in accordance with an illustrative embodiment.

FIG. 9 depicts a GUI showing a group profile, in accordance with an illustrative embodiment.

FIG. 10 depicts a third party App with an export icon for the present App, in accordance with an illustrative embodiment.

FIG. 11 depicts a computing system, in accordance with an illustrative embodiment.

The drawings are intended to depict only typical aspects of the disclosure, and therefore should not be considered as limiting the scope of the disclosure.

### DETAILED DESCRIPTION OF THE DISCLOSURE

Embodiments of the disclosure provide technical solutions for implementing a computerized platform to facilitate group based decision making via a computer network. In some aspects, the platform utilizes user-based client devices, such as smartphones, laptops, desktops, wearables, etc., to allow groups (i.e., two or more) of users to collaborate in a group decision making process. In other aspects, group based decision making can involve nodes in a network implemented with autonomous or artificial intelligence based systems, such as drones, autonomous vehicles, machine learning systems, bots, etc.

The present approach further addresses technical issues relating to group based decisions by providing a defined frame work that can better sequence decision points and automatically generate a sufficient number of appropriate and applicable options for a user to select from when making a decision. This provided solution overcomes technical issues associated with the generation of too many potential selections for a given decision point. Further, the solution includes a simple and familiar user interface to overcome what can otherwise be a cumbersome and overwhelming technical process.

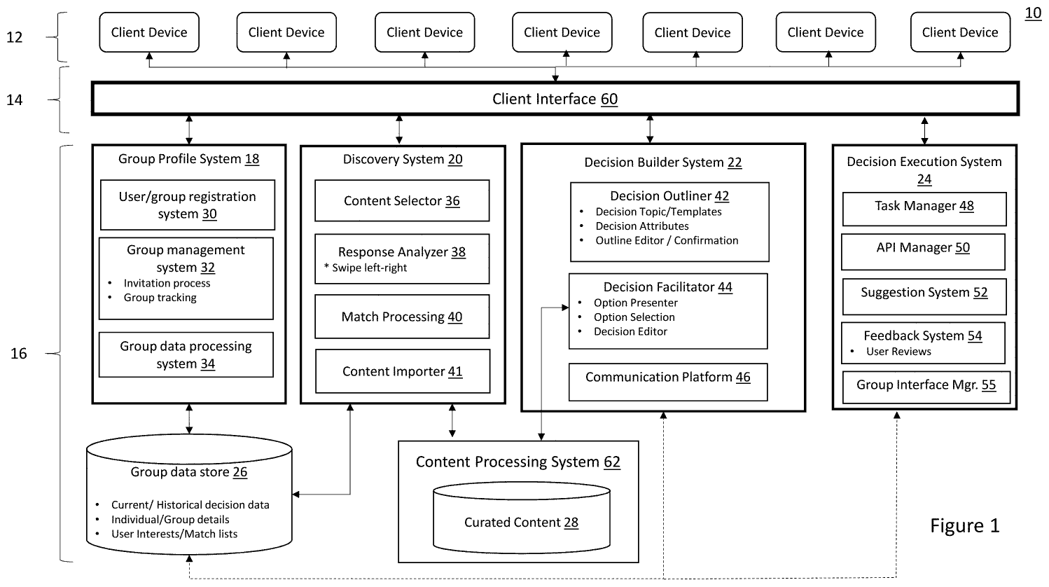

FIG. 1 depicts an illustrative decision making platform 10 that generally includes a set of client devices 12, a network infrastructure 14 that includes a client interface 60; and a decision processing system 16. In an illustrative aspect, each client device 12 includes an App that provides various graphical user interfaces (GUIs), various functionality, and a communication pathway with the decision processing system 16 via the network infrastructure 14. In general, decision processing system 16 is implemented as a server in a client-server architecture, including physical, virtual or cloud-based arrangements. In addition, it is understood that the functionality described herein may be implemented and distributed in any manner amongst any components of the platform 10.

In this illustrative embodiment, decision processing system 16 generally includes: a group profile system 18 for creating and managing group profiles and associated data; a discovery system 20 for discovering interests of different users, e.g., preferences, likes, choices, desires, etc.; a decision builder system 22 that manages the decision making process for a group; and a decision execution system 24 that facilitates execution of the decision for a group once made.

Group profile system 18 generally includes a user/group registration system 30 for registering a user and/or a group of users via client devices 12; a group management system 32 for creating and managing groups, including generating and managing group profiles; and a group data processing system 34 for managing decision data associated with existing groups. A group data store 26 stores data associated with registered users and groups, including user and group profiles (including likes and dislikes, matching interests, etc.), current and historical decision data generated by the decision processing system 16, user feedback, etc.

Depending on the intended purpose, a group may consist of two users, more than two users, multiple groups of user groups, or any other configuration of users or network nodes. Groups may for example be formed via an invitation process in which one user invites other users to form a group. In other cases, groups may be formed by an automated process in which group members are selected based on various criteria, such as preferences, location, etc. Once a group is formed, a group profile is generated specific to the group, and data associated with the group is collected and maintained in the group data store 26. Group data may for example include prior decisions made by the group, user feedback associated with a group decision, details on how a decision was arrived at, overlapping interests of the users in the group, typical roles of group members, related groups in which group users are members, attributes or characteristics of the group, etc. In some implementations, groups can be linked or clustered together with other similar groups.

As noted, the discovery system 20 provides a process through which interests of individual users can be collected, which then facilitates the group decision making process. In one embodiment, the discovery system 20 is intended to collect user interests separately from, or prior to, a group decision making process. In many cases, the discovery system 20 can be utilized by the user at their leisure, in order to avoid bias or agenda driving the user's decisions. In certain embodiments, the presentation of content items to a user within the discovery system 20 may be completely independent of the behavior of other users on the platform. In other embodiments, discovery system 20 may utilize responses of other users to influence presented content items. For example, actions by other users or group members having similar profiles or behaviors may be used to control presentation of content items.

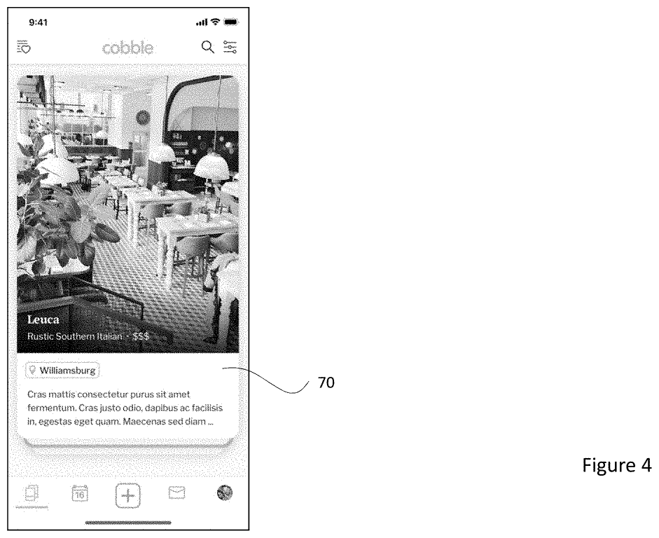

The discovery system 20 includes a content selector 36 that selects and presents curated content 28 to a user via a graphical user interface on the client device 12. In one illustrative embodiment, content is presented as a sequential set of content items that the user can respond to, e.g., by swiping left, right, etc., indicating like, dislike, undecided, etc. In one embodiment, content items are presented one at a time for the user to act upon, such that the user can only view one content item at a time. An example of such a content item 70 is shown in FIG. 4, which in this case involves a restaurant and includes an image, location information, description, and pricing information. Content items may be selected for presentation to a given user by the content selector 36 in any manner. In various approaches, displayed content items are determined as a result of a user search, a user selection, a determined user interest, etc. Content items may be further prioritized and selected based on profile information stored in the group data store 26, filters set by the user, interests of other group members, user location, known interests of the user, prior group decisions involving the user, current events, weather, upcoming group decisions involving the user, etc.

As noted, the presented content items may be responsive to a search query received from at least one of the client devices 12. As an example, the search query can be the form of the location (e.g., GPS data) of the client submitting the search query, user input received by the computing device submitting the search query, and the like.

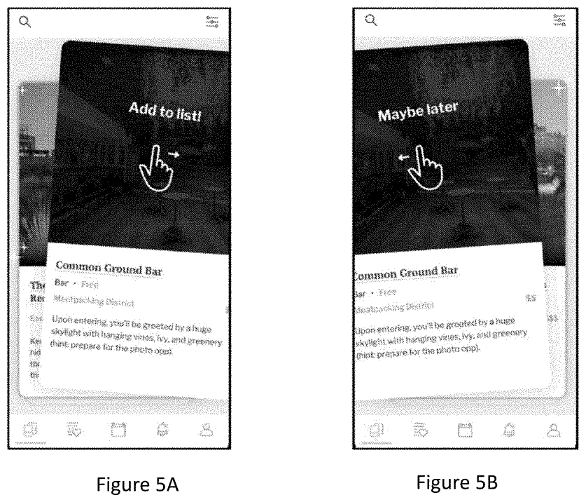

Content items can be provided to the user of the client device 12 for display within a GUI in the form of sequentially presented content frames (i.e., frames). An illustrative embodiment of a frame that depicts a content item 70 is illustrated in FIG. 4. As shown, the content item 70 provides visual details of the content, e.g., a photo, a description, content details, cost, date and time information, location, etc. In some embodiments, while viewing the content item 70, the user can respond with a positive interest for the content item (i.e., “select,” “like,” “add,” etc.) by swiping in a first direction, e.g., as shown in FIG. 5A, or show a lack of interest in the content item (i.e., “avoid,” “dislike,” “Maybe later,” etc.) by swiping in a second direction, e.g., as shown in FIG. 5B. Additionally, while viewing a content item, the user is able to obtain supplementary information associated with the content items. For example, by swiping up, more detailed information may be presented in the frame, including, e.g., a map, reviews, additional photos, links, suggestions to view related content items, etc.

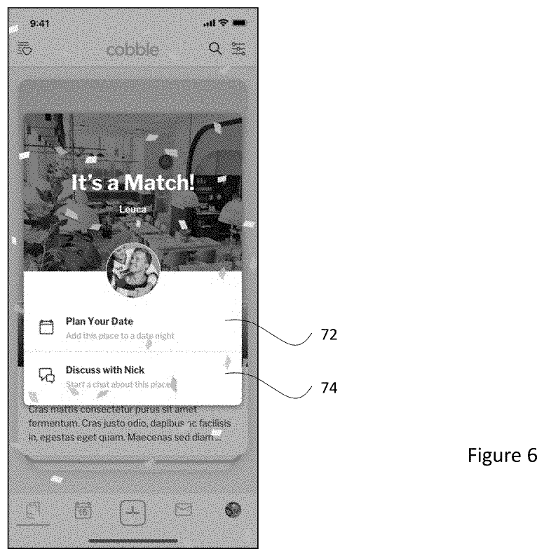

Referring again to FIG. 1, as the user responds to presented content items, response analyzer 38 collects, analyzes, and stores the responses (e.g., in the group data store 26). In addition to storing the responses, match processing 40 may be utilized to detect matching interests of the user with others in the user's groups. For example, if a group consists of the two users, and both swiped the same way on the same content item (indicating a positive interest by both members), a match would be detected and recorded. If a match is detected, the interest match may be stored in a match list in the group data store 26. In addition, the interest match may also be reported to both users via their respective client devices 12, an example of which is shown in FIG. 6. If a match is detected, the user may be presented with the option of initiating the decision builder system 22. For example, as shown in FIG. 6, the user is presented with the option 72 “Plan Your Date,” which will begin the decision building process. In this case, the user is also provided with the option to chat 74 with other group members about the match. As noted, in various embodiments, the discovery system 20 is intended to operate separately, or in parallel, to actual decision making by the decision builder system 22. In typical embodiments, users of the platform 10 can interface with the discovery system 20 at their leisure, regardless of whether a decision process involving the user is occurring or not. Further, as noted, during the discovery process, content items are presented to the user one at a time for the user to consider and express interest, potential interest, or non-interest (generally referred to as “interests”). Over time, a large set of interests for each user of the platform 10 may be captured, which can then be leveraged by the decision builder system 22. In addition, as described in further detail below, a content importer 41 may be deployed to import content of interest being viewed by a user from third party services such as third party Apps and other content sources.

When a user is ready to obtain a group based decision, the user launches the decision builder system 22 which may be implemented via a second GUI. Decision builder system 22 generally includes a decision outliner 42 that is used to outline the general parameters of the group based decision (e.g., determine the group members, topic, categories, attributes, etc.); a decision facilitator 44 that presents options to, and obtains selections from, members of the group, potentially in an iterative manner, to obtain consensus on a decision; and a communication platform 46 that handles the communication flow among members of the group.

In typical embodiments, each group involved in a decision includes an “initiator” (e.g., who generally drives the process and first typically initially engages with the decision builder system 22) and “other members” of the group. In such an embodiment, the initiator engages with the decision outliner 36 to configure an outline of a desired decision. In certain embodiments, the outline is based on a selected outline template for a particular topic. For example, if the decision involves a business decision being made by an executive team, a business decision template can be selected; if the decision involves a date night for a couple, a couple experience decision template can be selected; if the decision involves a collaborative remodeling/construction effort, a construction template can be selected; if the decision involves a family purchase, a purchasing template can be selected; etc. Other illustrative decision outlines may for example include topics such as a new product release, hiring decision, resource deployment, strategic planning, and so on. As is evident, the number and type of decisions that can be handled by platform 10 is virtually unlimited.

Each such template can be created by, e.g., a system administrator, and be maintained by the platform 10. As is evident, a given group decision may one or more elements, i.e., “decision points” that make up the overall decision, each of which must have consensus to finalize the overall decision. For example, in deciding to purchase a new vehicle, a couple may need to decide on the price range, make, vehicle type, color, features, etc.

Accordingly, the purpose of the decision outliner 36 is to provide an outline that specifies a set of selectable attributes that allows the initiator to present a framework of the decision, which indicates all of the required decision points. For example, the outline topic may specify a date night for a couple and the available attributes may for example include dinner, show, drinks and/or dessert, as well as date and time options. Further, sub-attributes of any of the main attributes may also be defined that for instance include a location, dinner cuisine type, price range, etc. In such as case, the initiator could narrow down the scope of the date night to dinner and a show, and provide a neighborhood, date and time, and price range. In the case of a remodeling project, the main attributes may specify different rooms in house, and the sub-attributes may specify furniture, appliances, color schemes, etc. In such a case, the initiator could specify kitchen remodel, and decision points may comprise appliances that need to be selected. In various embodiments, the purpose of the outline is not to provide actual selections or values that make up a decision, but rather narrow down the attributes to provide a framework of decision points for the overall decision.

Accordingly, once an initiator has selected a topic, the initiator can specify a group and customize the decision outline with various selected attributes. For example, in the case of date night, the initiator might initially specify a date, a price range for dinner, and a neighborhood for dessert. In certain embodiments, once the initiator configures the outline utilizing the decision outliner 42, the outline can be communicated to other members of the group via the communication platform 46 for confirmation. The other members can, e.g., approve, reject, propose new and/or edit the outline. For example, in a kitchen remodel decision, one of the members might recall that a new microwave also needs to be purchased, and can edit the outline using an outline editor to add the microwave decision point. In a date night example, a spouse may realize that she has a time conflict at the proposed time and edit the outline with a new proposed time. The decision outliner 42 facilitates the process until confirmation of the outline is provided by all members of the group. In other implementations, the decision outline may only require review and approval by a subset of users in the group.

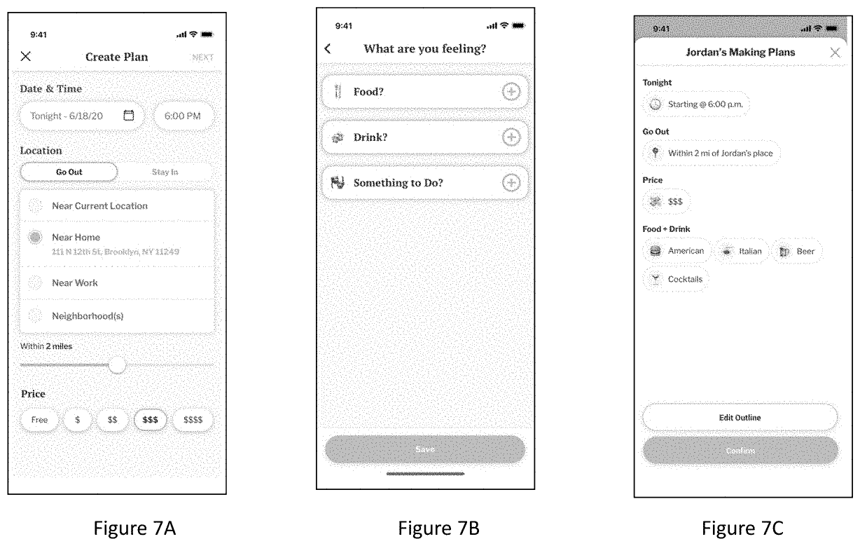

An illustrative GUI implementation of the decision outliner 42 for creating an outline is shown in FIG. 7A, 7B, 7C (in this embodiment referred to as a “plan” for a date night). In FIG. 7A, the user first selects some general attributes, e.g., date and time, location and price. Next, as shown in FIG. 7B, the user is presented with some general categories, e.g., food, drink, and something to do. Then, as shown in FIG. 7C, the user is able to finalize an outline that includes a selected time and date, location attributes, price attributes, and food and drink options.

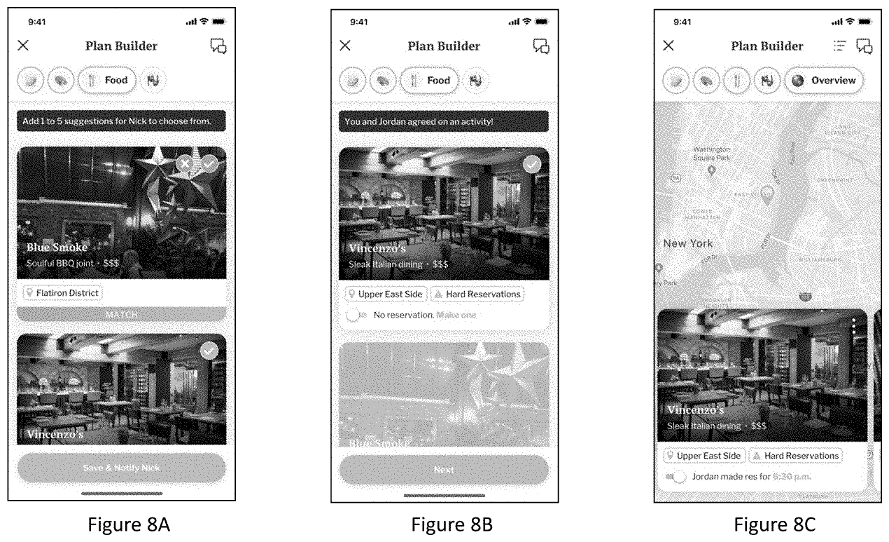

Once the decision outline is finalized for the group, decision facilitator 44 automates the process of completing the decision utilizing curated content 28. In one illustrative embodiment, decision facilitator 44 first presents the initiator with a scrollable list of content items (i.e., referred to as “designated options”) for each attribute that requires a decision. For example, as shown in FIG. 8A in which the decision points include selecting a restaurant for dinner and selecting a show, the initiator would first be presented with a list of restaurants from which the initiator would be required to make at least N selections, where N is a predetermined number, e.g., 1-5. In this case, the initiator can click on a check box in the upper right corner of each content item to select (or remove) a content item. Then, the initiator would be presented with a list of shows (not shown), and likewise be required to make at least M selections (where M is likewise some predetermined number). The results of the initiator's selections (i.e., a subset of content items) would then be sent to the other members of the group, who would then select from the initiator's selections. As shown in FIG. 8B, the other member of the group has selected a restaurant from the subset to form a consensus on the restaurant decision. FIG. 8C shows an overview screen with map information, reservation details, etc., of the decision.

In some cases, the other member or members would be required to make a final selection (i.e., select only one of the initiator's subset of selections). In other cases, the other member(s) may be allowed to select more than one of the initiator's selections. In still other cases, the other member(s) may be allowed to not select any of (i.e., reject) the initiator's selections. Depending on which case is implemented, and how many group members exist, an iterative or round robin process may be utilized in which selections are passed back and forth among the group members until a consensus is reached and a decision is finalized. In some cases, additional content item options may be added to the list presented to group members by the decision facilitator if consensus cannot be reached based on the initiator's or group member's selections. In other implementations, in which a consensus is not reached, the initiator may be provided with the option of making a final decision on a decision point, e.g., if there are multiple matches within the group. In still other implementations, decision builder system 22 may automatically make a decision.

The designated list provided to the initiator by the decision facilitator 44 (e.g., as shown in FIG. 8A) is selected from the curated content 28 based largely on the results of the discovery system 20. In one illustrative embodiment, various levels of relevance are assigned to content items for presentation in the initiator's list. The most relevant content items are those in which a match among the group members was established by the discovery system 20, i.e., all of the members swiped right on the same content item. A second level of relevance may involve content items in which some, but not all, of the group members showed an interest. A third level of relevance may involve content items in which no decisions regarding interest were captured by the discovery system 20. A fourth level may involve content items that were not yet reviewed and/or processed by content processing system 62, i.e., items that might be available, e.g., via a third party search engine, but have not been vetted. The process for selecting, arranging, ordering, and displaying the initiator's list may be done using any algorithm or process.

As noted, communication platform 46 facilitates communication among group members. In one embodiment, communication is provided within the Apps running on the client devices 12 of each group member. For instance, when the initiator creates an outline or creates a subset of options, the outline and/or options are presented to the other members with their respective Apps. In other embodiments, e.g., when a non-initiator member does not have the App installed, is not running the App, or opted out of the feature, an alternative lightweight messaging system (e.g., SMS, email, IM, etc.) may be utilized to communicate with such other members. For example, communication system 46 may simply generate and send a text message to the user with an enumerated list of options, to which the user can reply to (e.g., by typing a number). The reply would likewise be handled by the communication system 46 and passed to the decision facilitator 44 for processing. In other cases, the message may include a text version of the outline and simply require a yes/no response.

Once a decision is finalized by the decision builder system 22, decision execution system 24 may be deployed to facilitate implementation of the decision. Decision execution system 24 may for example include: a task manager 48 that schedules and reminds the group member of relevant dates and milestones; an application programming interface (API) manager 50 that links with third party systems, such as reservation systems, point of sale systems, calendar systems, GPS/mapping systems, HR systems, accounting systems, social media systems, etc.; a suggestion system 52 that can facilitate last minute changes, if for example, a decision element cannot be fulfilled (e.g., a purchase choice becomes unavailable, a restaurant wait is too long, a candidate declines a position, etc.); a feedback system 54 that collects user feedback regarding the decision (e.g., ratings, written or video commentary regarding elements of the decision, the decision process, other group members, etc.), and a group interface manager 55 that allows group members to jointly access and interface with a third party App (e.g., such as a shared group shopping cart at an ordering site).

It is understood that platform 10 represents one possible computerized implementation for implementing a decision making process 16, and other implementations in which the components are combined or distributed in different configurations could likewise be implemented without departing form the core concepts of the invention.

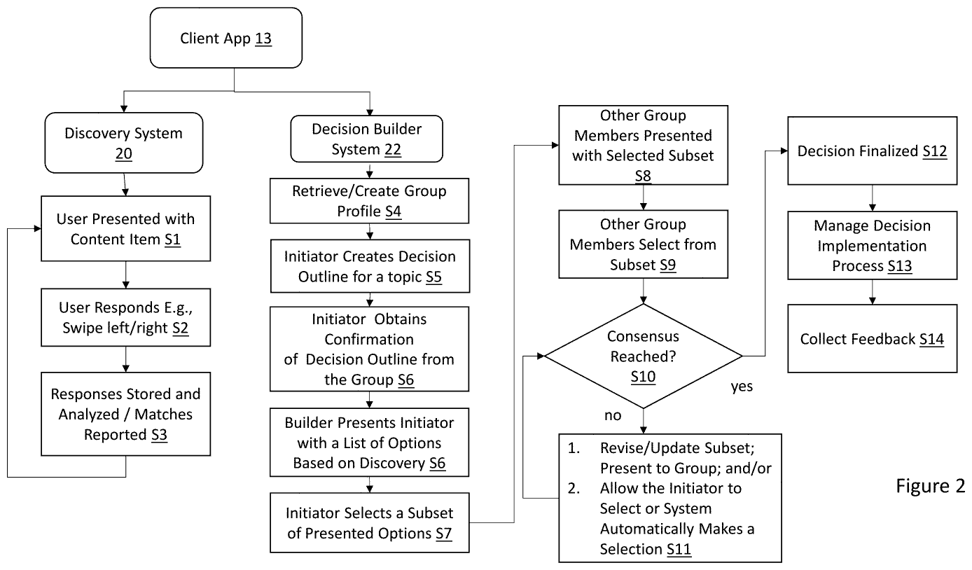

Referring now to FIG. 2, a flow diagram is presented showing illustrative processes for engaging with the discovery system 20 and/or decision builder system 22 from a client App 13, e.g., running on a client device 12. In the case where the user interfaces with the discovery system 20, the user is presented with sequentially presented content items, e.g., as shown in FIG. 4. Next, at S2, the user responds to a presented content item, e.g., by swiping left, right, etc., and at S3, the user response is stored and analyzed. If a match is detected with other group members, the interest match can be reported to the members, e.g., as shown in FIG. 6. The process repeats as long as the user desires to review content items within the client App 13.

In the case where the user (i.e., initiator) engages with the decision builder 22, the process first creates or retrieves at S4 a group profile for the members of the group involved in the decision process. Next, the initiator creates a decision outline for a topic (or selected topic) at S5. At S6, the initiator obtains confirmation of the decision outline from the other members of the group. If necessary, other members can edit or propose changes to the outline. Next, at S6, the initiator is presented with a list of content item options (i.e., the “designated list”) by the decision facilitator 44 (FIG. 1). At S7, the initiator selects a subset of presented options (e.g., 3-5 for each attribute of the decision), and at S8 the other members are presented with the selected subset for each decision point. At S9, the other members select from each subset. As noted, depending on the implementation, the other members can select just one option for each decision point, can select multiple options from each subset, or select none of the options. At S10, a determination is made whether a consensus has been reached. For example, in the case of a group with two members (the initiator and one other), if the other member selects just a single content item from the initiator's subset of selections for each attribute, then a consensus is reached. In other cases, e.g., involving a large group, a majority rule or other criteria can be utilized to trigger a consensus. If a consensus is not reached at S10, then at S11 the initiator's list and/or subset presented to group members can be further revised or updated and new lists can be presented to members of the group until a consensus is reached. In some cases, this may involve an iterative process in which content item options are iteratively presented to, and then accepted/rejected by the group until consensus is reached. Depending on the implementation, options can be presented to all members at the same time, in a round robin fashion, or any other approach.

In an alternative or additional approach at S11, if no consensus is reached, e.g., all the members select or match on more than one content item from the initiator's subset of selections, then the initiator can choose from amongst the unanimous selections either manually or initiate the decision builder system 22 to make the final selection either randomly or via an intelligent algorithm, thereby reaching a consensus.

Once a consensus is reached at S10 for each decision point, the decision is finalized at S12 and implementation of the decision is thereafter managed at S13 (e.g., via task manager 48, API manager 50, and suggestion system 52). Finally, after the decision is acted upon, feedback is collected at S14.

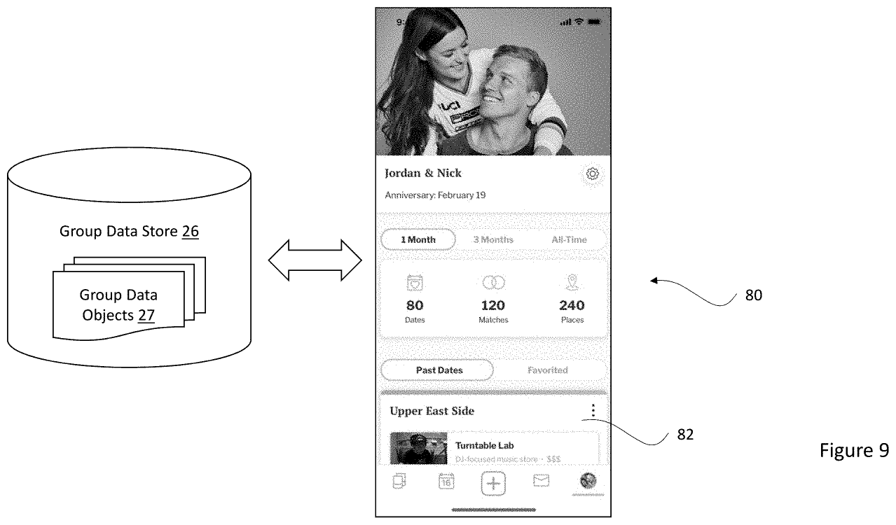

A noteworthy feature of the decision making platform 10 (FIG. 1) is the concept of a group profile, in which profile data associated with a set of users may be maintained in a unique group data object 27 (as shown in FIG. 9). For example, for a given group, the group data object 27 may include as attributes information about each member, how long the group has been in existence, information about prior decisions made by the group, a record of content items for which a match was detected by different group members, details associated with prior decisions that were implemented, links to content items associated with the group, etc. It is understood that the term “data objects” in this context is not intended to be limited to a particular programming construct, and such data objects may for example comprise traditional object oriented structures for holding group profile information, dynamic data objects that are temporally created for a particular decision making process, database records, tables, data structures, etc.

FIG. 9 also depicts an example of a group profile GUI 80 that depicts information from an illustrative group data object, e.g., selected from a set of group data objects 27 stored in group data store 26. In this illustrative embodiment, the group data object is structured to contain data for a couple, and the GUI 80 shows information from the group data object, i.e., profile data is displayed regarding their group history, including number of prior decisions (i.e., dates), number of content item matches, number of decision attributes (i.e., places) that were implemented, etc. Also shown in the GUI 80 is a content item summary 82 involving past decisions.

In addition to being useful for displaying group profile information, group data objects 27 can also be processed by group data processing system 34 (FIG. 1) to, e.g., analyze and mine for data such as overlapping interests of the members of a group, identify or cluster groups with similar group profiles, provide matching and other information to the decision builder system 22, be utilized as input to a machine learning system to predict interests for the group, for making recommendations, etc.

In a further implementation, the group profiles can be leveraged by group interface manager 55 (FIG. 1) to allow all members of a group to simultaneously interface with a third party service (e.g., a third party App). For example, if the decision is made to order food from a restaurant using a delivery service (e.g., DoorDash, GrubHub, etc.), group interface manager 55 would allow each user to simultaneously utilize their App on separate devices to access a shared group shopping cart at the delivery service App. In an illustrative embodiment, group interface manager 55 would first read in the group data object for the group, identify the group members and relevant settings and arrange for a shared interface for the group members with the third party service. In this case, the group data object may include payment details for the group, e.g., which member or members are tagged to pay and how, a running balance for members, options for how the members should be reimbursed, etc.

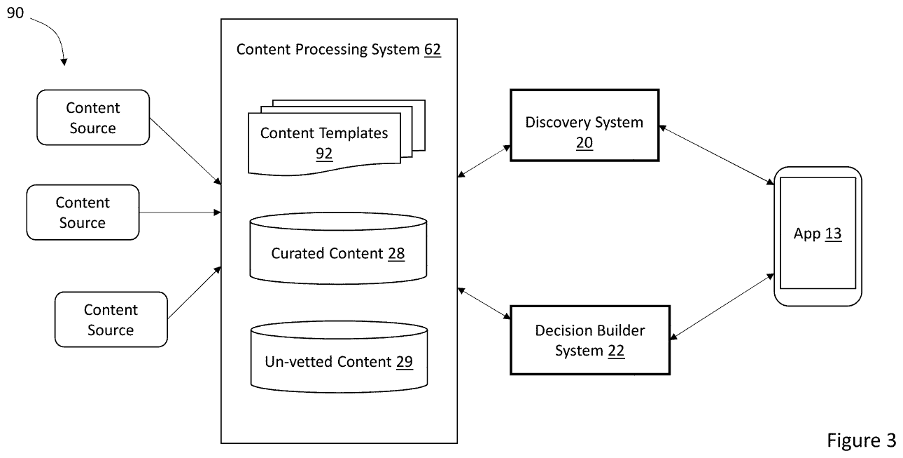

Returning to FIG. 3, further details of content process system 62 is shown, which provides content items to both the discovery system 20 and the decision builder system 22. In various implementations, the format and presentation of content items for the end user can be an important component of the decision making process. Regardless of the type of decision being made, each content item being presented to a user via App 13 should ideally have a consistent, high quality appearance, which connotes a similar level of textual and visual details. For example, if a set of group members are viewing content items associated with travel ideas and locations, then each content item should provide the same type of information in a similar format in order to assure that the presentation itself is not influencing a user's interest. For instance, a content item with a low quality image and few details is likely to garner less interest than a content item with a high definition image and many details. To facilitate a consistent presentation, a set of content templates 92 may be utilized that ensures inputted content sources 90 conform to a certain quality level before being stored as curated content 28. Each template may for example include fields for key information (title, summary, etc.), a region for an image or video, a region for a written description, reviews, location, etc.

As noted, in some cases, such as when a group cannot reach a consensus regarding a decision attribute, un-vetted content 29 may be presented as a potential option via the decision builder system 22. Un-vetted content 29 may for example include content items pulled from a content source 90 that have not yet been fully curated, content provided by users, etc.

In some implementations, content processing system 62 may include an automated process for inputting and curating content items. In some cases, a machine learning system, e.g., utilizing natural language processing (NLP) may be utilized to analyze unstructured content (e.g., raw or un-vetted content items, websites, news feeds, social media, etc.) and generate structured content that can automatically be integrated with a content template to create curated content items. In some cases, image processing and analytics can also be used to automatically evaluate image data, ensure quality and content, etc.

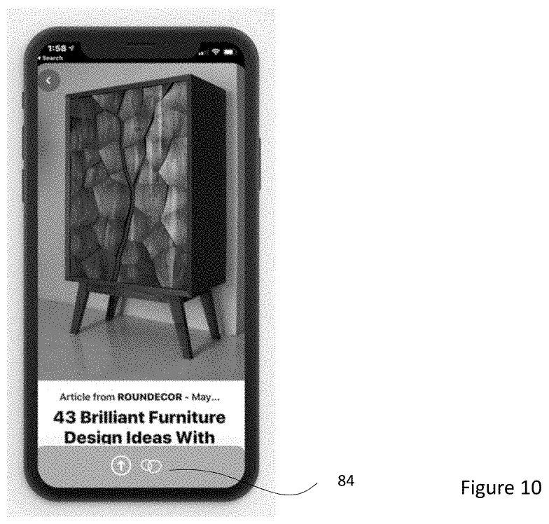

In other cases, content items may be inputted to the content processing system 62 and/or decision facilitator 44 directly from users utilizing the App. For example, the App can include an interface for taking a photo and entering text to and create a content item. In another embodiment, discovery system 20 may include a content importer 41 (FIG. 1) that allows a user to import content items when utilizing third party Apps, browsers, etc. For example, as shown in FIG. 10, while viewing an image of a product within a third party shopping App, the user can simply tap the export icon 84, in this case installed using standard iOS functionality (similar to saving or sharing to a social media platform, etc.). Content importer 41 will import the exported content being viewed on the third party App and, e.g., forward the content to content processing system 62. The imported content may include an image, a link, a video, a program, etc. The ability to export can be effectuated via the operating system once the App is installed on the phone, tablet, or other client device, and an option for exporting content to the App from within other third party Apps will be displayed. In other cases, browser plugins or the like may be similarly utilized to capture and export content.

Decision making platform 10 provides significant advantages over other forms of group decision making. In particular, through its more efficient and simpler interface, the decision making platform 10 properly handles the numerous decision points, either concurrently or sequentially, upon which the ultimate decision depends, and provides an optimal number of qualified selections. Additionally, each user is able to independently view and contemplate options during both the discovery process and decision building process without interference, coercion and/or biases of the other users. If a given user does not like a particular option, the user is free to reject the option without consequence. Further, each user is able to discover interests or make their selections along their own time line, without being rushed or forced to make decisions simultaneously with the other members during a time-limited meeting or via disjointed chains of emails, texts and other communication interfaces. Along these lines, presenting users with curated content (as opposed to voicing options and opinions), users are able to take a deeper dive into different options. Moreover, the decision making process provides an optimized solution to quickly eliminate points of disagreement and arrive at points of agreement.

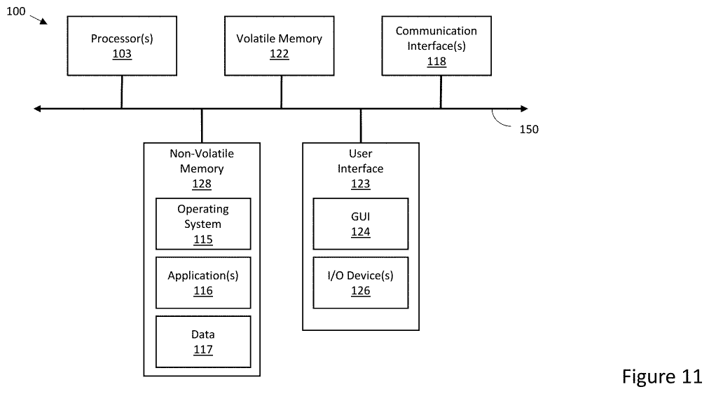

FIG. 11 depicts a block diagram of a computing device 100 useful for practicing an embodiment of platform 10. The computing device 100 includes one or more processors 103, volatile memory 122 (e.g., random access memory (RAM)), non-volatile memory 128, user interface (UI) 123, one or more communications interfaces 118, and a communications bus 150.

The non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

The non-volatile memory 128 stores an operating system 115, one or more applications 116, and data 117 such that, for example, computer instructions of the operating system 115 and/or the applications 116 are executed by processor(s) 103 out of the volatile memory 122. In some embodiments, the volatile memory 122 may include one or more types of RAM and/or a cache memory that may offer a faster response time than a main memory. Data may be entered using an input device of the GUI 124 or received from the I/O device(s) 126. Various elements of the computer 100 may communicate via the communications bus 150.

The illustrated computing device 100 is shown merely as an example client device or server, and may be implemented by any computing or processing environment with any type of machine or set of machines that may have suitable hardware and/or software capable of operating as described herein.

The processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

In some embodiments, the processor 103 may be one or more physical processors, or one or more virtual (e.g., remotely located or cloud) processors. A processor including multiple processor cores and/or multiple processors may provide functionality for parallel, simultaneous execution of instructions or for parallel, simultaneous execution of one instruction on more than one piece of data.

The communications interfaces 118 may include one or more interfaces to enable the computing device 100 to access a computer network such as a Local Area Network (LAN), a Wide Area Network (WAN), a Personal Area Network (PAN), or the Internet through a variety of wired and/or wireless connections, including cellular connections.

In described embodiments, the computing device 100 may execute an application on behalf of a user of a client device. For example, the computing device 100 may execute one or more virtual machines managed by a hypervisor. Each virtual machine may provide an execution session within which applications execute on behalf of a user or a client device, such as a hosted desktop session. The computing device 100 may also execute a terminal services session to provide a hosted desktop environment. The computing device 100 may provide access to a remote computing environment including one or more applications, one or more desktop applications, and one or more desktop sessions in which one or more applications may execute.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

As will be appreciated by one of skill in the art upon reading the following disclosure, various aspects described herein may be embodied as a system, a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A system, comprising:
a memory; and
a processor coupled to the memory and configured to facilitate decision making for a group by implementing:
an interest discovery process that includes:
outputting curated content items to client devices for display;
receiving and storing responses from the client devices, wherein each response is indicative of an interest in a displayed content item for a user; and
identifying interest matches among group members based on the responses; and
a decision builder process that includes:
receiving a decision outline from an initiator via a client device, wherein the decision outline specifies at least one required decision point;
outputting designated content items to the initiator capable of fulfilling the required decision point, wherein the designated content items are compiled based on interest matches made by the interest discovery process;
receiving a subset of the designated content items from the initiator and outputting the subset to at least one other group member;
receiving from the at least one other group member a choice associated with the subset and determining whether a consensus is obtained by the group for the decision point.

2. The system of claim 1, wherein the interest discovery process further includes reporting interest matches to group members via respective client devices.

3. The system of claim 1, further including requesting confirmation of the decision outline from other members of the group.

4. The system of claim 1, wherein the decision outline is created from a template for a selected topic.

5. The system of claim 1, wherein the designated content items outputted to the initiator include:
curated content items in which an interest match was detected for all members of the group;
curated content items in which at least one group member responded with an interest;
curated content items in which no group members responded; and
content items not presented by the interest discovery process and un-vetted by a content processing system.

6. The system of claim 1, wherein the decision builder system includes retrieves or builds a group profile for the group, wherein the group profile tracks prior decisions of the group, overlapping interests of the group and prior decision implementation details for the group.

7. The system of claim 1, wherein the choice associated with the subset from the at least one other group member includes one of: a single selection from the subset; multiple selections from the subset; and no selections from the subset.

8. The system of claim 7, wherein the consensus is obtained when all members of the group agree to a single selection.

9. The system of claim 8, wherein, in response to a determination that no consensus is obtained, iteratively presenting members with updated content items choices and obtaining selections until a consensus is reached.

10. The system of claim 1, further comprising a process for managing implementation of a decision point, including:
tracking tasks associated with the decision point;
providing third party services via an application programming interface;
suggesting alternatives when a decision point becomes unavailable; and
collecting feedback.

11. A computer program product stored on a non-transitory computer readable medium, which when executed by a computing system having a processor and a memory, facilitates a group decision making process, the program product comprising:
a first graphical user interface (GUI) for discovering user interests that includes a method of:
displaying curated content items;
receiving user input responses, wherein each response is indicative of an interest in a displayed content item; and
outputting the responses to a remote server; and
a second GUI that facilitates a decision making process for a group of users by an initiator that includes a method of:
generating a decision outline in response to user selectable inputs, wherein the decision outline specifies at least one required decision point;
displaying designated content items capable of fulfilling the required decision point, wherein the designated content items are compiled based on interest matches between the initiator and at least one other group member;
collecting user input selections from the designated content items that form a subset of designated content items, and forwarding the subset to the server for dissemination to the at least one other group member; and
receiving, via the server, a choice from the subset made by the at least one other group member, indicating a consensus for the decision point.

12. The computer program product of claim 11, wherein the curated content items are presented in a sequential manner such that only one curated content item is displayed at a time.

13. The computer program product of claim 12, wherein the user input responses made in the first GUI are inputted via a swipe left/swipe right action.

14. The computer program product of claim 13, wherein the first GUI further includes displaying supplemental information about a displayed curated content item in response to a swipe up action.

15. The computer program product of claim 12, wherein designated content items capable of fulfilling the required decision point are displayed by the second GUI as a scrollable list, such that multiple content items are viewable in the second GUI.

16. The computer program product of claim 11, further comprising interface elements for facilitating implementation of a decision, including at least one of a task manager, a map interface, and a third party point of sale interface.

17. The computer program product of claim 11, further comprising a suggestion system that suggests alternatives when the decision point becomes unavailable after being finalized.

18. The computer program product of claim 11, further comprising a feedback system for collecting user feedback associated with the decision point.

19. The computer program product of claim 11, further comprising a messaging interface for communication with group members.

20. The computer program product of claim 11, further comprising a group profile interface for viewing information associated with the group.
